(19) United States
(12) Patent Application Publication
(10) Pub. No.: US 2012/0066767 A1
(43) Pub. Date: Mar. 15, 2012

(54) METHOD AND APPARATUS FOR PROVIDING COMMUNICATION WITH A SERVICE USING A RECIPIENT IDENTIFIER

(75) Inventor: Markku Kalevi Vimpari, Oulu (FI)

(73) Assignee: Nokia Corporation, Espoo (FI)

(21) Appl. No.: 12/880,797

(22) Filed: Sep. 13, 2010

(51) Int. Cl. H04L 9/00

(52) U.S. Cl. 726/26

(57) ABSTRACT

An approach is presented for providing communication with a service using a recipient identifier. The data communication platform receives a request to generate a recipient identifier for indicating data exchanged between a service and an application on a device. Further, the data communication platform determines user identifier, one or more device identifiers associated with the device, one or more application identifiers associated with the application, or a combination thereof. Then, the data communication platform determines to generate the recipient identifier by encoding, at least in part, the user identifier, the one or more device identifiers, the one or more application identifiers, or a combination thereof in the recipient identifier. In one embodiment, the recipient identifier may be encrypted. The user identifier, the one or more device identifiers, the one or more application identifiers, or a combination thereof are decodable directly from the recipient identifier.

### BACKGROUND

Service providers and device manufacturers (e.g., wireless, cellular, etc.) are continually challenged to deliver value and convenience to consumers by, for example, providing compelling network services. One area of development of has been the integration or coordination of multiple services by enabling one service to communicate to a device, even when the service is a third party to the device. For example, a mobile telephone device may receive information from a first party service such as the mobile phone service provider as well as from a third party service such as an independent social networking service. With an increasing number of the third party services and uses of the third party services, it is desirable to provide an effective communication between different types of services and the device. In order to access the device by the service, information such as information to route the communication by the service to the device needs to be conveyed to the service. However, due to the third party nature of the third party service, it may be preferable to prevent the third party service from accessing some information about the device or the identity of the human recipient.

### SOME EXAMPLE EMBODIMENTS

Therefore, there is a need for an approach for providing communication with a service using a recipient identifier, such that the communication between the service and the device may be performed more securely.

According to one embodiment, a method comprises receiving a request to generate a recipient identifier for indicating data exchanged between a service and an application on a device. The method also comprises determining a user identifier, one or more device identifiers associated with the device, one or more application identifiers associated with the application, or a combination thereof. The method further comprises determining to generate the recipient identifier by encoding, at least in part, the user identifier, the one or more device identifiers, the one or more application identifiers, or a combination thereof in the recipient identifier. The user identifier, the one or more device identifiers, the one or more application identifiers, or a combination thereof are decodable directly from the recipient identifier.

According to another embodiment, an apparatus comprises at least one processor, and at least one memory including computer program code, the at least one memory and the computer program code configured to, with the at least one processor, cause, at least in part, the apparatus to receive a request to generate a recipient identifier for indicating data exchanged between a service and an application on a device. The apparatus is also caused to determine a user identifier, one or more device identifiers associated with the device, one or more application identifiers associated with the application, or a combination thereof. The apparatus is further caused to determine to generate the recipient identifier by encoding, at least in part, the user identifier, the one or more device identifiers, the one or more application identifiers, or a combination thereof in the recipient identifier. The user identifier, the one or more device identifiers, the one or more application identifiers, or a combination thereof are decodable directly from the recipient identifier.

According to another embodiment, a computer-readable storage medium carries one or more sequences of one or more instructions which, when executed by one or more processors, cause, at least in part, an apparatus to receive a request to generate a recipient identifier for indicating data exchanged between a service and an application on a device. The apparatus is also caused to determine a user identifier, one or more device identifiers associated with the device, one or more application identifiers associated with the application, or a combination thereof. The apparatus is further caused to determine to generate the recipient identifier by encoding, at least in part, the user identifier, the one or more device identifiers, the one or more application identifiers, or a combination thereof in the recipient identifier. The user identifier, the one or more device identifiers, the one or more application identifiers, or a combination thereof are decodable directly from the recipient identifier.

According to another embodiment, an apparatus comprises means for receiving a request to generate a recipient identifier for indicating data exchanged between a service and an application on a device. The apparatus also comprises means for determining a user identifier, one or more device identifiers associated with the device, one or more application identifiers associated with the application, or a combination thereof. The apparatus further comprises means for determining to generate the recipient identifier by encoding, at least in part, the user identifier, the one or more device identifiers, the one or more application identifiers, or a combination thereof in the recipient identifier. The user identifier, the one or more device identifiers, the one or more application identifiers, or a combination thereof are decodable directly from the recipient identifier.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing communication with a service using a recipient identifier, according to one embodiment;

FIG. 2 is a diagram of the components of the data communication platform, according to one embodiment;

FIG. 3 is a flowchart of a process for providing communication with a service using a recipient identifier, according to one embodiment;

FIG. 4 is a flowchart of a process for routing the data from the service using the recipient identifier, according to one embodiment;

FIG. 5 is a flowchart of a process for performing encryption for the recipient identifier, according to one embodiment;

FIG. 6 is a block diagram of the processes of FIGS. 3 and 4, according to one embodiment;

FIG. 7 is a diagram of hardware that can be used to implement an embodiment of the invention;

FIG. 8 is a diagram of a chip set that can be used to implement an embodiment of the invention; and

FIG. 9 is a diagram of a mobile terminal (e.g., handset) that can be used to implement an embodiment of the invention.

### DESCRIPTION OF SOME EMBODIMENTS

Examples of a method, apparatus, and computer program for providing communication with a service using a recipient identifier are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

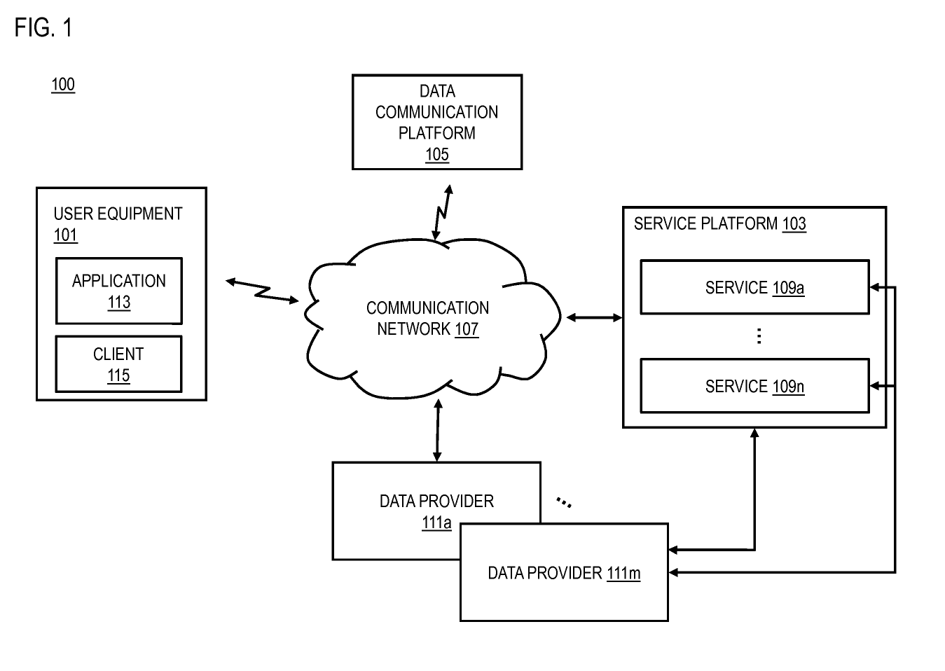

FIG. 1 is a diagram of a system capable of providing communication with a service using a recipient identifier, according to one embodiment. As discussed above, when interacting with services, especially with third party services, it is preferable for a user to hide certain information such as a user identity (e.g., Jabber Identifier (JID) for messaging services, other unique user identifiers, etc.) or device identifier (e.g., mobile number, electronic serial number (ESN), mobile equipment identifier (MEID), etc.) from the third party services and application developers. For example, when a device receives a notification from a third party service such as a social networking service or a music service, it is desirable to make the identity of the user or the device unknown or otherwise hidden to the service and/or a third party application developers. Traditionally, one way to provide these features is to generate tokens for users, which are stored in a database for corresponding users. The tokens may be randomly generated, and thus may hide the user identity. When a token is received, a database of generated tokens may be searched to find the user data (e.g., identifier of a user and/or a particular device of the said user) related to the received token. Another traditional way to provide these features is to calculate a hash of the information to be hidden and storing the hash in a database. When a hash is received, the database is searched for the same hash. However, both of these methods may cause significant burdens in maintaining of the database as the amount of data stored in the database increases, which can be caused by an increased number of devices and users as well as applications using the database. Therefore, an approach to hide the user identity while minimizing the burden on maintenance of the database is desired.

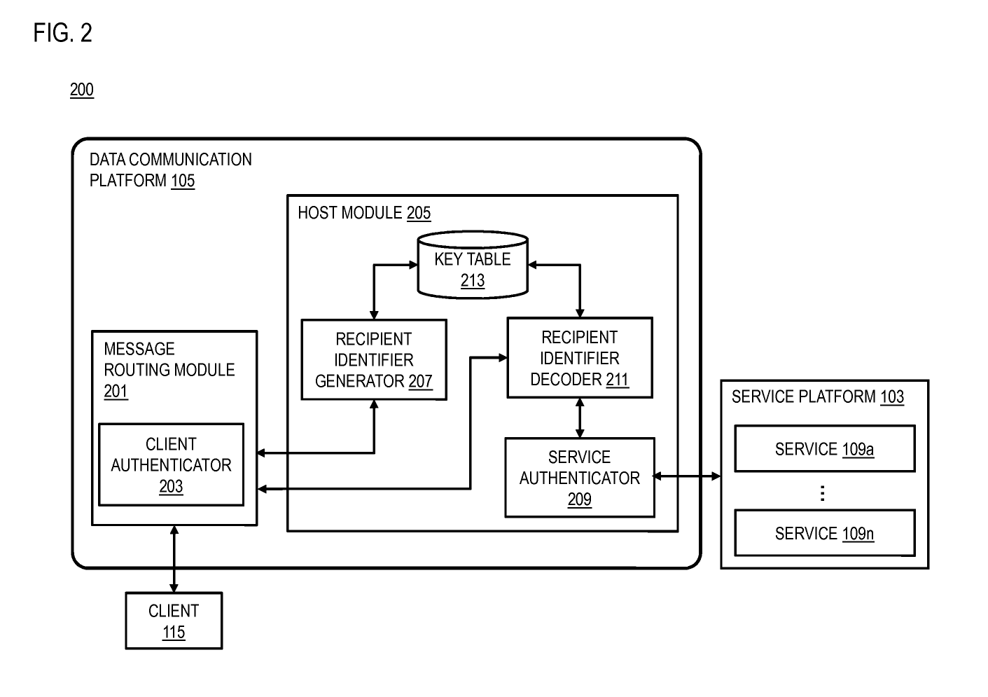

To address this problem, a system 100 of FIG. 1 introduces the capability to provide communication with a service using a recipient identifier that encodes potentially sensitive information (e.g., user identifiers, device identifiers, etc.) in a way that protects the information while also enabling authorized services to decode or otherwise access the information without need to maintain a database of such information. More specifically, the system 100 receives a request to generate a recipient identifier for indicating data exchanged between a service and an application on a device. In one embodiment, the recipient identifier may include information to identify the device and/or user receiving the data, and the application that is to use the data, and the like. Accordingly, the system 100 determines, at least in part, a user identifier, one or more device identifiers associated with the device, one or more application identifiers associated with the application, or a combination thereof, which are then encoded and used to generate the recipient identifier. In one embodiment, the information is encoded in the recipient identifier in such a way that the user identifier, the device identifiers and the application identifiers are directly decodable from the recipient identifier. As used herein, the “directly decodable” means, for instance, that the user identifier, the device identifiers and/or the application identifiers may be extracted or derived from the recipient identifier without using a lookup table or database of the identifiers. In one embodiment, both the encoding and decoding processes are performed by applying computations the respectively generate or use the recipient identifier as described in more detail with respect to FIGS. 2-7B below.

After generating the recipient identifier, the system 100 transmits the generated recipient identifier to the application and/or to the service. In approach described herein, the recipient identifier is transmitted without providing or otherwise disclosing the encoded information (e.g., the user identifier, the device identifiers, the application identifiers, etc.) to the third-party application and/or service. In certain embodiments, the system 100 may transmit the generated recipient identifier to the application, which then sends it to the service. In addition or alternatively, the system 100 may transmit the recipient identifier directly to the service. Because the user identifier and/or the device identifiers are encoded in the recipient identifier and cannot be read without decoding them, the identity of the device or the user is hidden from the application and the service. In some embodiments, the application identifier may also be encoded in the recipient identifier, and thus be hidden from the service. Further, the dynamic encoding and decoding enables the system 100 to use the recipient identifiers without needing to maintain a database of the recipient identifiers and their corresponding information payload (e.g., the user identifier, the device identifiers, the application identifiers). This avoids maintenance of a large database of the recipient identifiers for different devices and applications.

After the recipient identifier is provided to the application and/or service. The system 100 then may receive data tagged with the recipient identifier from the service. For example, the data may include messages for notification such as a status update message of another user from a social networking service, and the status update message is to be presented via an application in a device as the notification. Then, the system 100 decodes the user identifier, the device identifiers and/or the application identifiers from the received data, and routes the data to the appropriate device and/or application based on the device identifiers and/or the application identifiers. As discussed previously, the decoding is performed directly from the recipient identifier without reference to external databases or lookup tables that might link the recipient identifier with corresponding device and/or application identifiers.

As shown in FIG. 1, the system 100 comprises a user equipment (UE) 101 having connectivity to a service platform 103 and a data communication platform 105 via a communication network 107. In one embodiment, the source of the data available for user access may be the service platform 103, the one or more services 109a-109n of the service platform 103, the one or more data providers 111a-111m, and/or other data services available over the communication network 107. For example, a service 109a may obtain data (e.g., notification messages or media content) from a data provider 111a to deliver the obtained data to the UE 101. The service platform 103, services 109a-109n, and/or content providers 111a-111m may provide data such that the data may be sent to the UE 101 via the communication network 107. Each of the services 117a-117n, for instance, may provide different content and/or different types of services (e.g., a social networking service, a messaging service or a music service). Some of services 109a-n may be provided with a different quality of service like guaranteed throughput based on the service level agreement between the data communication and service provider. The recipient identifier may be used to mediate the data from the data source (e.g., services 109a-109n, data providers 111a-111m) to the UE 101 and/or the application 113 within the UE 101.

In one embodiment, the UE 101 includes or executes an application 113 that is a client of the service 109. For example, the application 113 may be an instant messaging client that receives message notifications from the corresponding service 109 (e.g., instant messaging service). In the approach described herein, the application 113 may request a recipient identifier for identifying a recipient for data (e.g., messages, notifications, etc.) that are transmitted from the service 109 to the application 113. In one embodiment, the application 113 may send the request to the client 115 that is configured to communicate with the data communication platform 105. As shown, the client 115 also executes or is resident in the UE 101 and is responsible for reformulating the request from the application 113 so that the recipient identifier can be generated by the communication platform 105. In this embodiment, the client 115 and the data communication platform 105 work in cooperation to enable the generation of recipient identifiers while protecting potentially sensitive identifiers (e.g., device identifiers, user identifiers, etc.) from exposure to third-party applications and/or services. More specifically, because the application 113 (e.g., a third party application) does not know or have access to specific identifiers associated with the UE 101, the request from the application 113 does not include such identifiers. However, these identifiers are often needed for routing data from the service 109 to the application 113. Accordingly, the client 115 receives the request from the application 113 and reformulates the request by adding the device identifiers, user identifiers, etc. The client 115 then transmits the request to the communication platform 105 for processing and generation of the requested recipient identifier. Because the client 115 and the communication platform 105 are part of closed or protected system for generating and processing recipient identifiers, sensitive identifiers are not exposed to either the application 113 or the service 109.

By way of an example, the application 113 may send the request to the client 115 by calling a device enabler application programming interface (API). As noted above, the client 115 may then reformulate this request to include potentially sensitive information related to the user or the device (e.g., UE 101). In this way, the sensitive information is not exposed to the application 113. For example, the request may include an application identifier of the requesting application, a user identifier, a device identifier, a service identifier for which the recipient identifier is sent, and etc. The device identifier may be combined with the user identifier as a single identifier, such as a Jabber Identifier (JID). This request may then be sent from the client 115 to the data communication platform 105 via the communication network 107. Using the information included in the received request, the data communication platform 105 generates the recipient identifier by encoding the identifier information provided by the client 115. As previously noted, the recipient identifier encodes the identifier information in a way that protects the information from exposure while remaining directly decodable by authorized components or processes (e.g., components and/or processes of the communication platform 105).

Then, the data communication platform 105 transmits the generated recipient identifier to the client 115, which in turn forwards the recipient identifier to the application 113. The application 113 then sends the received recipient identifier to the service 109 so that that subsequent data (e.g., messages, notifications, etc.) exchanged between the application 113 and the service 109 may be identified accordingly. In this way, the identity of the device (e.g., UE 101) or the user is hidden from the service 109 because the user identifier and/or the device identifiers are encoded in the recipient identifier. In one embodiment, the service 109 may utilize the recipient identifier to send data via the data communication platform 105 to the application 113 without knowing the specific identifiers of the target UE 101. By way of example, for the service 109 to send data (e.g., messages, notifications) to the UE 101, the service 109 first sends the data and the corresponding recipient identifier to the data communication platform 105. The data communication platform 105 then decodes the recipient identifier to determine the application identifier, the user identifier and/or the device identifier (e.g., JID), or any other information. The data communication platform 105 then routes the data to the determined UE 101 and/or application 113 without exposing the identifier information to the application 113 or the service 109. In one embodiment, the data along with the converted information (e.g., the application identifier, device identifier, the user identifier, etc.) is transmitted to the client 115 of the UE 101 that corresponds to the converted information (e.g., the user/device identifier). The client 115 then delivers the data to the application 113 based on the converted information (e.g., the application identifier). The recipient identifier is hidden from the third party application such as the application 113.

In one embodiment, the data communication platform 105 may encrypt the user identifier, the device identifiers and/or the application identifiers. Thus, for example, the data and the identifier of the target device may be included in the recipient identifier in an encrypted form. Further, the recipient identifier may be generated based on the encrypted user identifier, device identifiers and/or the encrypted application identifier. The target user identifier and/or device identifier may be a jabber identifier (JID) of an extensible messaging and presence protocol (XMPP). The recipient identifier may also contain a message authentication code (MAC) such as a hash-based message authentication code (HMAC), so that the integrity (as well as the authenticity) of the recipient identifier may be validated using the MAC.

In another embodiment, the recipient identifier may be encrypted using a symmetric cipher such as a strong symmetric cipher (e.g., 256 bit advanced encryption standard (AES)) or an asymmetric cipher. The symmetric cipher may be based on one or more keys. For example, the data communication platform 105 may select a primary key for the symmetric cipher based on the service identifier associated with the service. In particular, the primary key may be selected based on a hash of input data containing the service identifier, service level and predetermined parameters. Further, the data communication platform 105 may also generate a secondary key for the symmetric cipher based on the HMAC constructed from the service identifiers, predetermined parameters (e.g., service level), or a combination thereof. For example, the secondary key may be a HMAC composed using a key table of primary keys, the service identifiers, predetermined parameters.

After generating the recipient identifier and transmitting it to the application 113, the data communication platform 105 need not store the generated recipient identifier for any subsequent reference because the data communication platform 105 can reconstruct or decode the recipient identifier when needed. In one example, the generated recipient identifier may be temporarily stored at a cache type of storage such as a random access memory (RAM). Because the recipient identifier is not stored or is stored at a cache temporarily, this provides an advantage in that it is not necessary to maintain a database to store a large amount of data involving the recipient identifiers of different users and devices.

Therefore, the advantage of this approach is that the system 100 provides a novel way to provide communication between the service and the device, while hiding the identity of the device and avoiding maintenance of database for storing the recipient identifiers. Because the recipient identifier is used to route the data from the service and includes the encoded user identifier, device identifiers and application identifiers, the service does not have access to the identity of the devices and/or the users by only accessing the recipient identifier. As a result, the identity of the devices and/or the users may be hidden from the service while providing information to route the data from the service. Further, the recipient identifier is temporarily stored in a temporary storage until the recipient identifier is transmitted, and thus this approach avoids maintaining a large database of the recipient identifiers of various devices, services and users. Accordingly, means for providing communication with a service using a recipient identifier are anticipated.

By way of example, the communication network 107 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

By way of example, the UE 101, a service 109 and a data communication platform 105 communicate with each other and other components of the communication network 107 using well known, new or still developing protocols. In this context, a protocol includes a set of rules defining how the network nodes within the communication network 107 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

In one embodiment, the client 115 and the data communication platform 105 interact according to a client-server model. It is noted that the client-server model of computer process interaction is widely known and used. According to the client-server model, a client process sends a message including a request to a server process, and the server process responds by providing a service. The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others.

FIG. 2 is a diagram of the components of the data communication platform 105, according to one embodiment. By way of example, the data communication platform 105 includes one or more components for providing communication with a service using a recipient identifier. It is contemplated that the functions of these components may be combined in one or more components or performed by other components of equivalent functionality. In this embodiment, the data communication platform 105 includes a message routing module 201 having a client authenticator 203 and a service host module 205 having a recipient identifier generator 207, a service authenticator 209, a recipient identifier decoder 211, and a key table 213. The message routing module 201 manages/controls any incoming and outgoing communications such as transfer of the files or data, including the information regarding the user identifiers, the device identifiers and the application identifiers with the client 115 and the service host module 205. The client authenticator 203 authenticates the client 115 such that communication between the message routing module 201 and the client 115 may be enabled. The recipient identifier generator 207 generates the recipient identifier based on the user identifiers, the device identifiers and/or the application identifiers received from the message routing module 201. The recipient identifier may mediate the data exchanged between the UE 101 and the service platform 103, the service 109 and/or the data provider 111. In particular, the recipient identifier may be used to route the data from the service 109 to a corresponding application (e.g., application 113) in a corresponding device (e.g., UE 101). The recipient identifier generator 207 also performs encryption, and may also rely on the key table 213 in encrypting the recipient identifier. The key table may be shared with the recipient identifier decoder or the generator and the decoder may have substantially identical copies of it. The recipient identifier generator 221 communicates the message routing module 201 to receive information related to the recipient identifier. The service authenticator 209 provides interface with the services 109a-109n and/or the service platform 103 to receive the data and the recipient identifier from the services 109a-109n. The recipient identifier decoder 211 receives the data and the recipient identifier from the service authenticator 209 and decodes the recipient identifier. The recipient identifier decoder 211 is also capable of sending the decoded recipient identifier and the data to the message routing module 201.

In one embodiment, the recipient identifier generator 207 receives a request via the message routing module 201 to generate a recipient identifier. This request may be received from the client 115, which creates this request in response to an application's request for a recipient identifier from the application 113. The received request may include an application identifier corresponding to the application (e.g., application 113) used to receive the data, a device identifier corresponding to the device (e.g., UE 101) having the application and a service identifier corresponding to the service (e.g., service 109) sending the notification. Sensitive information such as the device identifier and the user identifier, etc. may be included for the request sent from the client 115 to the data communication platform 105, but not for the application's request sent from the application 113 to the client 115. Thus, the sensitive information is unknown to the application 113, which may be a third party application. The device identifier may be an address for a target device, and may be a Jabber Identifier (JID) of the XMPP protocol, which may also include a user identifier.

Upon receiving the request to generate the recipient identifier, the recipient identifier generator 207 determines the user identifier, the device identifiers and/or the application identifiers, and then generates the recipient identifier by encoding the user identifier, the device identifiers and/or the application identifiers. The recipient identifier is generated such that these device identifiers and/or application identifiers can be decoded directly from the said recipient identifier. Once the recipient identifier is generated, the recipient identifier generator 207 transmits the generated recipient identifier, without providing the user identifier, the device identifiers or the application identifier. By way of example, the recipient identifier generator 207 may transmit, via the message routing module 201, the generated recipient identifier to the client 115 of the device (e.g., UE 101) corresponding to the user, device and application identifiers, such that the client 115 can forward the recipient identifier to the application 113. In one example, after the transmission of the generated recipient identifier, the recipient identifier may not need to be stored at the data communication platform 105 or any storage medium, for any subsequent reference. Thus, the recipient identifier may be discharged after transmission from the data communication platform 105 to the UE 101 or it can be stored temporarily at a cache type of storage such as a random access memory (RAM).

When the recipient identifier generator 207 generates the recipient identifier, it may perform encryption for the recipient identifier. In one embodiment, the recipient identifier generator 207 encrypts the user, identifier, the device identifiers and/or the application identifiers. The recipient identifier generator 207 generates the recipient identifier based on the encrypted user, device and/or application identifiers or combinations of them. Thus, the recipient identifier may carry the user identifier, the device identifier and the application identifier in an encrypted form. The recipient identifier generator 207 may also generate a message authentication code such as a HMAC to be included in the recipient identifier. Then, the recipient identifier generator 207 may later validate the integrity of the recipient identifier by examining the HMAC in the recipient identifier. Further, recipient identifier generator 207 may encrypt the recipient identifier using a symmetric cipher, such as a strong symmetric cipher (e.g., 256 bit AES) or an asymmetric cipher. This encryption using the cipher may include selecting a primary key for the cipher based on the service identifiers and generating a secondary key based on a HMAC constructed from the service identifiers and predetermined parameters (e.g., service level), etc. For example, the recipient identifier generator 207 may select a primary key based on a hash of an input data containing the service identifiers. The primary key may be selected from the key table 213 having primary keys to be selected based on the service identifiers. The key table 213 may contain a high number of primary keys so that the probability that the two different services utilize the same primary key is low. Further, for example, the secondary key may be a HMAC composed based on the key table 213, the service identifiers and predetermined data.

The application 113 may receive the generated recipient identifier and send it to the service 109. The service 109 then may send data (e.g., notifications) to the UE 101 based on the information encoded in the recipient identifier. In one embodiment, the service authenticator 209 authenticates the service 109 from which the data is transmitted. Upon authentication of the service 109, the service authenticator 209 receives the data from the service 109, wherein the data includes the recipient identifier, and the data is routed to the recipient identifier decoder 211. Then, the recipient identifier decoder 211 decodes the user identifier, the device identifiers and/or the application identifiers directly from the received data. In other words, the user identifier, the device identifiers and/or application identifiers can be derived from the recipient identifier without using any external information such as a look-up table or a database. In one example, the user identifier, the device identifiers and/or the application identifiers may be decoded directly from the recipient identifier included in the data. The message routing module 201 then routes the data to the application 113 based on the device identifiers and/or the application identifiers. This routing does not expose user identifier and/or the device identifiers to the application 113, and thus hides the identity of the user and/or the device from the application 113. By way of an example, the recipient identifier decoder 211 may send, via the message routing module 201, the data with the user and device identifier such as the JID and/or the application identifier to the client 115 of the device corresponding to the user and device identifier. Then, the client 115 may send the data to the application corresponding to the application identifier.

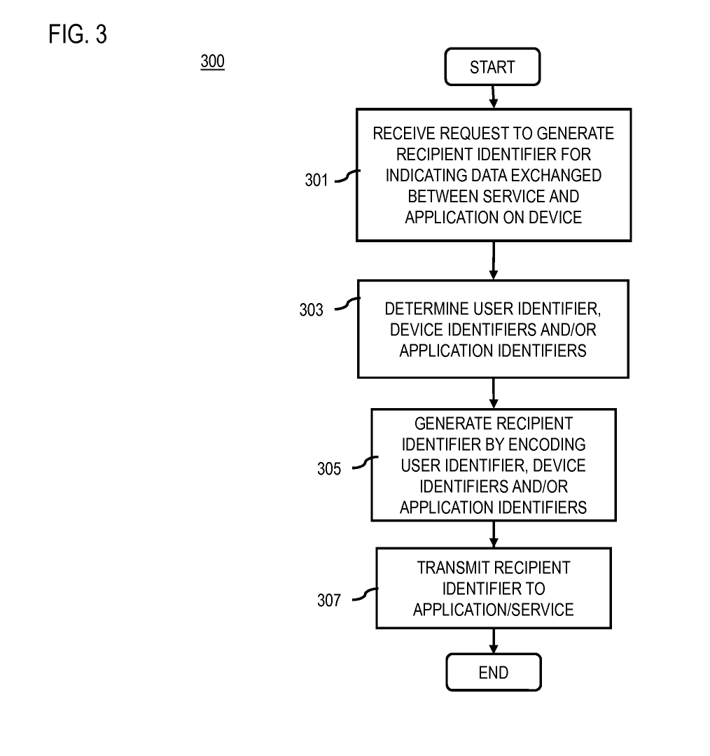

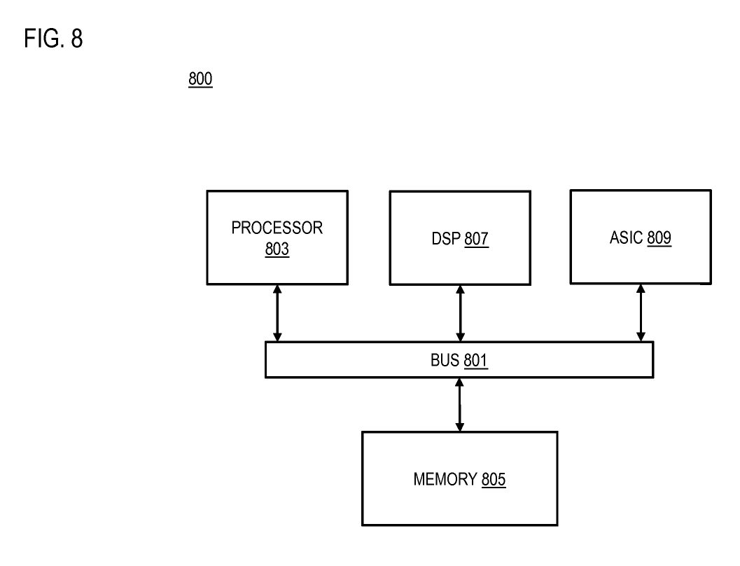

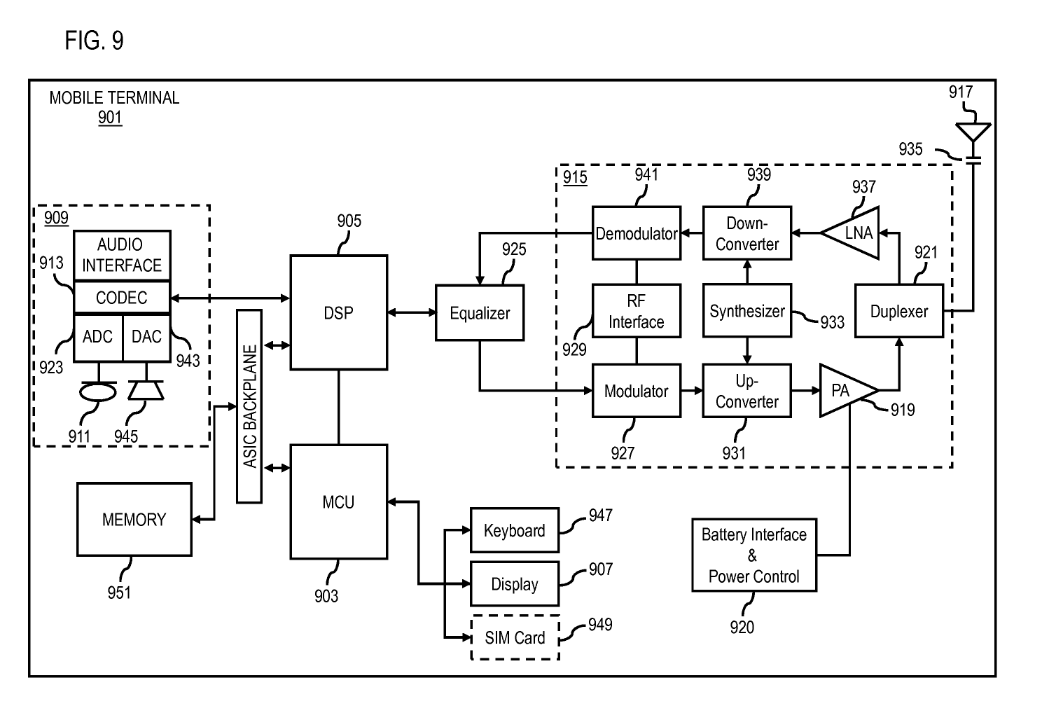

FIG. 3 is a flowchart of a process for providing communication with a service using a recipient identifier, according to one embodiment. In one embodiment, the data communication platform 105 performs the process 300 and is implemented in, for instance, with a computer system as shown in FIG. 8 or a chip set including a processor and a memory as shown in FIG. 9. In step 301, the data communication platform 105 receives a request to generate a recipient identifier for indicating data exchanged between a service and an application on a device. The recipient identifier indicates the data exchanged between the application 113 and the service 109 in the service platform 103. Thus, the recipient identifier may include information related to the user, the device and the application to which the data from the service 109 are to be sent, for example. Before the data communication platform 105 receives the request to generate the recipient identifier, the application 113 in the UE 101 first sends a request for the recipient identifier to the client 115 in the UE 101. This request may be sent to the client 115 by calling the device enabler API. Because the application 113 may be a third party application, it may be advantageous to make the sensitive information unknown to the application 113. Hence, in one embodiment, sensitive information including identity of the user or the device may not be accessible by the application 113. As a result, this application's request from the application 113 may include the application identifier corresponding to the application 113, but may not include the sensitive information such as the device identifier and the user identifier.

Then, the client 115 sends the request to the data communication platform 105, which is the request received at the data communication platform 105 to generate the recipient identifier. This client's request from the client 115 may be reformulated from the application's request from the application 113 so as to include the sensitive information such as the user identifier and the device identifier corresponding to the UE 101. The client 115 may be configured to perform communication with the data communication platform 105, whereas the application 113 may be configured to perform communication with the service 109 and the client 115. Thus, in one embodiment, the application 113 may be able to request for the recipient identifier to the data communication platform 105 only via the client 115.

In step 303, the data communication platform 105 determines the user identifier, one or more device identifiers associated with the device, one or more application identifiers associated with the application, or a combination thereof. In one example, the device identifier may also be combined with a user identifier as a single identifier including a user identifier and the device identifier, such as a Jabber Identifier (JID). The user identifier and/or the device identifier identify the device to which the service 109 may send the notification, and the application identifier identifies the one or more applications to which the service 109 may send the notification. In one embodiment, when the request for the recipient identifier is sent from the client 115 to the data communication platform 105, the request may contain the user identifier, the device identifiers, the application identifiers and service identifiers for which the recipient identifier is requested. In other words, for a service communicating a notification message to an application of a device, corresponding service identifiers may be determined.

In step 305, the data communication platform 105 generates the recipient identifier by encoding, at least in part, the user identifier, the one or more device identifiers, the one or more application identifiers, or a combination thereof in the recipient identifier. The recipient identifier is generated such that the user identifier, the one or more device identifiers, the one or more application identifiers, or a combination thereof are decodable directly from the recipient identifier. Therefore, the recipient identifier includes information related to the user identifier, the device identifier(s) and/or the application(s) identifiers as well as other information, and such information may be derived from the recipient identifier without referencing to external information such as a database. Further, because the user identifier, device identifiers and the application identifiers are encoded in generating the recipient identifier, the information regarding the user identifier, the device identifiers and the application identifiers may not be accessible without decoding the recipient identifier. As a result, the recipient identifier hides this sensitive information from a third party service or a third party application developer, especially if the third party service or the third party application developer is not capable of decoding the recipient identifier. In one example, the data communication platform 105 may generate a message authentication code (MAC) for the recipient identifier and include the MAC in the recipient identifier. Then, the data communication platform 105 may check for the integrity of the recipient identifier by examining the MAC. In one example, the MAC may be a hash-based message authentication code (HMAC). Further, the recipient identifier may be generated to carry the user identifier, the device identifiers and the application identifiers in encrypted form. The encryption involving the notification is discussed in more details below.

In step 307, the data communication platform 105 transmits the recipient identifier to the application, the service, or a combination thereof without providing the user identifier, the one or more device identifiers to the application or the service. The data communication platform 105 may send the recipient identifier to the client 115, which sends the said recipient identifier to the application 113. The application 113 then transmits this recipient identifier to the service 109, such that the service 109 may utilize the recipient identifier to send data (e.g., notifications) to the application 113. The identity of the user and the device is hidden from the service 109 because the user identifier and/or the device identifiers are in an encoded form in the recipient identifier, and thus the service 109 cannot read the user identifier and/or device identifiers from the recipient identifier, as discussed above. Further, after the data communication platform 105 transmits the recipient identifier, the data communication platform 105 does not need to store the recipient identifier for any subsequent reference. The recipient identifier may be stored temporarily at a cache such as a random access memory (RAM). Because the data communication platform 105 is capable of encoding and decoding the recipient identifier dynamically, the recipient identifier and their corresponding information payload (e.g., the user identifiers, the device identifiers, and the application identifiers) do not need to be stored and maintained in a database. As a result, this approach may advantageously simplify the data communication involving the recipient identifier.

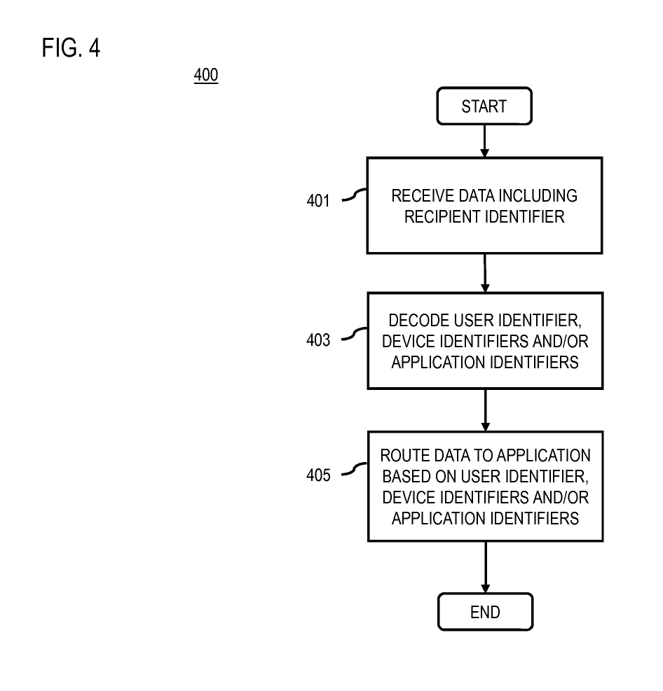

FIG. 4 is a flowchart of a process for routing the data from the service using the recipient identifier, according to one embodiment. In one embodiment, the data communication platform 105 performs the process 400 and is implemented in, for instance, computer system as shown in FIG. 8 or a chip set including a processor and a memory as shown in FIG. 9. In step 401, the data communication platform 105 receives data including the recipient identifier. In one embodiment, after the service 109 receives the recipient identifier from the application 113, the service 109 sends the data including the recipient identifier to the data communication platform 105. In one example, the data may include notification information to be sent to the UE 101 such that the UE 101 may present the notification from the service 109. In step 403, the data communication platform 105 decodes the one or more user identifier and/or the one or more device identifiers, the one or more application identifiers, or a combination thereof directly from the data. Thus, the decoded user identifier, the decoded device identifiers and/or the decoded application identifiers may be used to route the data (e.g., the data including notifications) to a corresponding device of corresponding user and a corresponding application. In step 405, the data communication platform 105 routes the data to the application based, at least in part, on the one or more user identifier, the one or more device identifiers, the one or more application identifiers, or a combination thereof. The data may be sent to the client 115 of the corresponding device (e.g., UE 101) of the corresponding user based on the decoded device and/or user identifiers. Then, the client 115 forwards the data to the corresponding application (e.g., application 113) based on the decode application identifiers. Then, the application 113 presents the notifications at the UE 101 based on the data. In this case, if the decoded user identifiers and/or the corresponding device identifiers are utilized when determining the corresponding device and the client 115 of the corresponding device of the corresponding user, but not utilized in determining the corresponding application, the identity of the user and device will be hidden from the application.

The processes shown in FIGS. 3 and 4 are advantageous in that these processes provide an effective and safe way to communicate between the service and the application in the device by using the recipient identifier to hide the identity of the device and/or the user from the service and/or the application. These processes involving the recipient identifier also provide simplicity in that the capability of dynamic encoding and decoding of the recipient identifier avoids maintaining a large database of recipient identifiers for various devices, users and applications. Thus, this process provides a secure way to communicate with a third party service, and saves cost and labor in maintaining a large database of the recipient identifiers. The data communication platform 105 is a means for achieving this advantage.

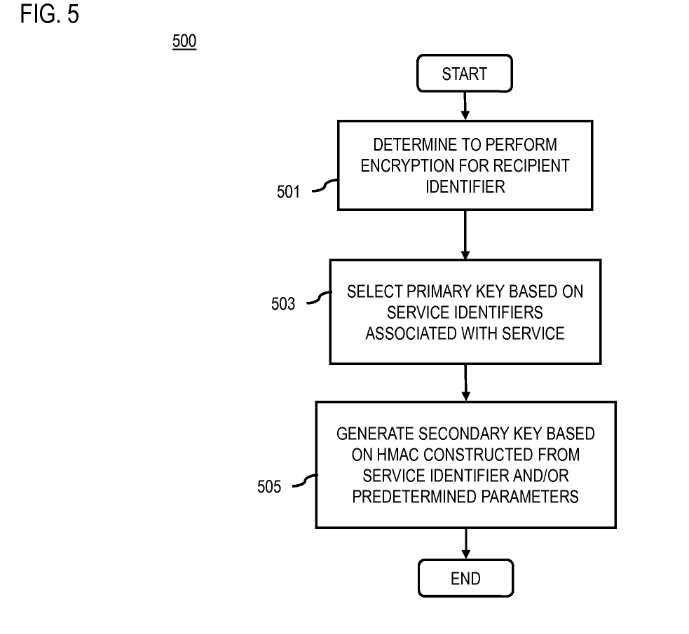

FIG. 5 is a flowchart of a process for performing encryption for the recipient identifier, according to one embodiment. In one embodiment, the data communication platform 105 performs the process 500 and is implemented in, for instance, a computer system as shown in FIG. 8 or chip set including a processor and a memory as shown in FIG. 9. In step 501, the data communication platform 105 determines to perform encryption of the recipient identifier. One way to perform encryption for the recipient identifier is to encrypt the user identifier and device identifiers and/or the application identifiers, such that the recipient identifier includes the user identifier, the device identifier and the application identifier in an encrypted form.

The data communication platform 105 may encrypt the recipient identifier using a symmetric cipher such as a strong symmetric cipher (e.g., 256 bit AES). The data communication platform 105 may utilize the primary key and the secondary key to encrypt the recipient identifier using the symmetric cipher. In step 503, the data communication platform 105 selects a primary key for the symmetric cipher based, at least in part, on one of the one or more service identifiers associated with the service. In step 505, the data communication platform 105 generates a secondary key for the symmetric cipher based, at least in part, on hash-based message authentication code (HMAC) constructed, at least in part, from the one of the one or more service identifiers one or more predetermined parameters (e.g., service level), or a combination thereof. The primary key may be selected based on the hash of an input data containing the service identifiers associated with the service one or more predetermined parameters, or a combination thereof. The primary key may be selected from the key table containing a number of primary keys. If the key table has a high number of primary keys (e.g., thousands of primary keys), the probability that two services utilize the same primary key is low. The secondary key may be a HMAC computed using the primary key, the service identifiers and the predetermined parameters. The secondary key is unique in that it is the service identifier specific. Thus, for two services having the primary keys that appear the same, the secondary keys are still always guaranteed to be different—due for the different services the service identifiers are unique.

The process shown in FIG. 5 is advantageous in that this process provide security by encrypting the recipient identifier. Because the recipient identifier may be accessed by a third party to extract information such as the identity of the device and/or the users, it is advantageous to have added security by encrypting the notification identifier. The data communication platform 105 is a means for achieving this advantage.

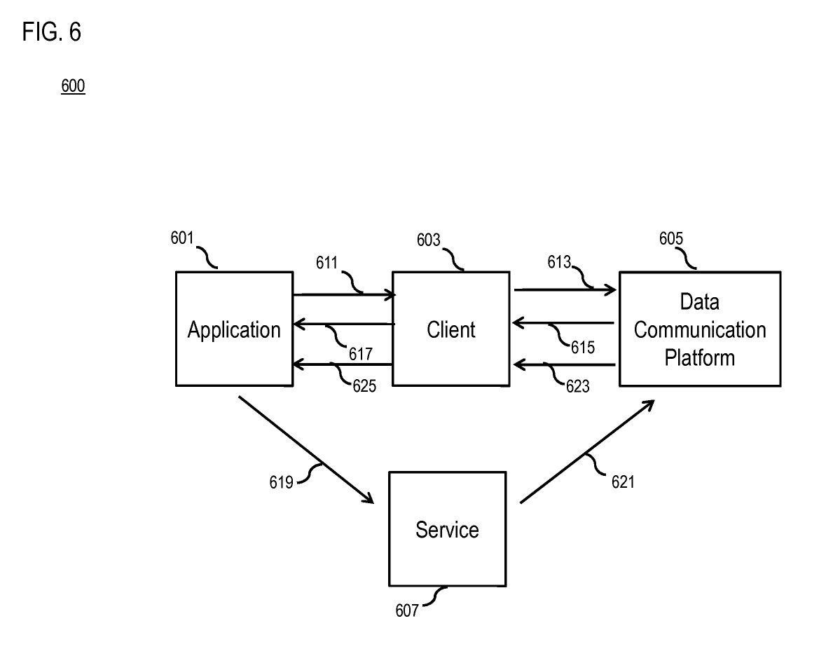

FIG. 6 is a block diagram of the processes of FIGS. 3 and 4, according to one embodiment. FIG. 6 shows a diagram 600 with the interactions among the application 601, the client 603, the data communication platform 605 and the service 607. In this embodiment, the application 601, the client 603, the data communication platform 605 and the service 607 may be equated to the application 113, the client 115, the data communication platform 105 and the service 109. In process 611, the application 601 requests for the recipient identifier, wherein this request may be performed by calling the device enabler API. This request may include the application identifier of the requesting application (e.g., the application 601) and the service identifier of the service (e.g., the service 607) to which the application 601 will send the recipient identifier, but may not include the device identifier of the requesting device and/or the user identifier, or any other sensitive information that should be unknown to the application 603 or the service 607. The client 603 receives this request, and sends a request to the data communication platform 605, in process 613. This request to the data communication platform 605 may be reformulated to include the user identifier as well as the device identifier of the requesting device. A single identifier that includes both the device identifier and the user identifier, such as the JID, may be used. The data communication platform 605 then generates the recipient identifier based on the request and the information included in the request, such as the user identifier, the device identifier, the application identifier, etc. When generating the recipient identifier, the data communication platform 605 also performs encryption for the recipient identifier, based on the service identifier, service level and some other data like pre-determined parameters, etc.

In process 615, the generated recipient identifier is sent to the client 603, and in process 617, the client 603 sends this recipient identifier to the application 601. Then, in process 619, the application 601 sends the recipient identifier to the service 607. The service 607 can utilize this recipient identifier to send data such as notification messages to the Application 601. To achieve this, the service 607 sends the data including the notification identifier to the data communication platform 605, in process 621. The data communication platform 605 decodes the user identifier and/or the device identifier(s) and/or the application identifier(s) from the received notification identifier. In process 623, the data along with the decoded user identifier and/or device identifiers and the decoded application identifiers is sent to the client 603 of the device corresponding to the decoded device identifiers. Then, in process 625, the data is sent from the client 603 to the application 610 based on the decoded application identifiers. If the data is a notification message, then the application 601 may present the data at the device as a notification from the service 607.

The processes described herein for providing communication with a service using a recipient identifier may be advantageously implemented via software, hardware, firmware or a combination of software and/or firmware and/or hardware. Such exemplary hardware for performing the described functions is detailed below.

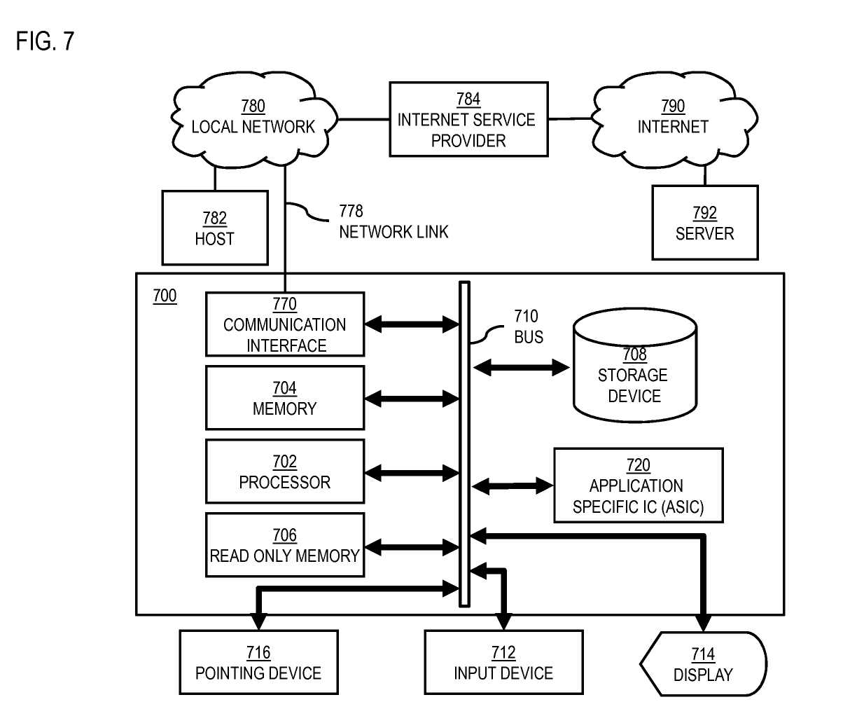

FIG. 7 illustrates a computer system 700 upon which an embodiment of the invention may be implemented. Although computer system 700 is depicted with respect to a particular device or equipment, it is contemplated that other devices or equipment (e.g., network elements, servers, etc.) within FIG. 7 can deploy the illustrated hardware and components of system 700. Computer system 700 is programmed (e.g., via computer program code or instructions) to provide communication with a service using a recipient identifier as described herein and includes a communication mechanism such as a bus 710 for passing information between other internal and external components of the computer system 700. Information (also called data) is represented as a physical expression of a measurable phenomenon, typically electric voltages, but including, in other embodiments, such phenomena as magnetic, electromagnetic, light, pressure, chemical, biological, molecular, atomic, sub-atomic and quantum interactions. For example, north and south magnetic fields, or a zero and non-zero electric voltage, negative or positive electric voltage, zero or non-zero electric current, negative or positive electric current, zero or non-zero electric charge, negative or positive electric charge, different level of positive of negative electric voltage, current of charge, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 700, or a portion thereof, constitutes a means for performing one or more steps of providing communication with a service using a recipient identifier.

A bus 710 includes one or more parallel conductors of information so that information is transferred quickly among devices coupled to the bus 710. One or more processors 702 for processing information are coupled with the bus 710.

A processor (or multiple processors) 702 performs a set of operations on information as specified by computer program code related to providing communication with a service using a recipient identifier. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 700 also includes a memory 704 coupled to bus 710. The memory 704, such as a random access memory (RAM) or any other dynamic storage device, stores information including processor instructions for providing communication with a service using a recipient identifier. Dynamic memory allows information stored therein to be changed by the computer system 700. RAM allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 706 or any other static storage device coupled to the bus 710 for storing static information, including instructions, that is not changed by the computer system 700. Some memory is composed of volatile storage that loses the information stored thereon when power is lost. Also coupled to bus 710 is a non-volatile (persistent) storage device 708, such as a magnetic disk, optical disk or flash card, for storing information, including instructions, that persists even when the computer system 700 is turned off or otherwise loses power.

In the illustrated embodiment, special purpose hardware, such as an application specific integrated circuit (ASIC) 720, is coupled to bus 710. The special purpose hardware is configured to perform operations not performed by processor 702 quickly enough for special purposes. Examples of ASICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface 770 coupled to bus 710. Communication interface 770 provides a one-way or two-way communication coupling to a variety of external devices that operate with their own processors, such as printers, scanners and external disks. In general the coupling is with a network link 778 that is connected to a local network 780 to which a variety of external devices with their own processors are connected. In some embodiments, a communication interface 770 is a cable modem that converts signals on bus 710 into signals into optical signals for a communication connection over a fiber optic cable. As another example, communications interface 770 may be a local area network (LAN) card to provide a data communication connection to a compatible LAN, such as Ethernet. Wireless links may also be implemented. For wireless links, the communications interface 770 sends or receives or both sends and receives electrical, acoustic or electromagnetic signals, including infrared and optical signals, which carry information streams, such as digital data. For example, in wireless handheld devices, such as mobile telephones like cell phones, the communications interface 770 includes a radio band electromagnetic transmitter and receiver called a radio transceiver. In certain embodiments, the communications interface 770 enables connection to the communication network 107 for providing communication with a service using a recipient identifier.

The term “computer-readable medium” as used herein refers to any medium that participates in providing information to processor 702, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 708. Volatile media include, for example, dynamic memory 704. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 720.

Network link 778 typically provides information communication using transmission media through one or more networks to other devices that use or process the information. For example, network link 778 may provide a connection through local network 780 to a host computer 782 or to equipment 784 operated by an Internet Service Provider (ISP). ISP equipment 784 in turn provides data communication services through the public, world-wide packet-switching communication network of networks now commonly referred to as the Internet 790.

A computer called a server host 792 connected to the Internet hosts a process that provides a service in response to information received over the Internet. For example, server host 792 hosts a process that provides information representing video data for presentation at display 714. It is contemplated that the components of system 700 can be deployed in various configurations within other computer systems, e.g., host 782 and server 792.

At least some embodiments of the invention are related to the use of computer system 700 for implementing some or all of the techniques described herein. According to one embodiment of the invention, those techniques are performed by computer system 700 in response to processor 702 executing one or more sequences of one or more processor instructions contained in memory 704. Such instructions, also called computer instructions, software and program code, may be read into memory 704 from another computer-readable medium such as storage device 708 or network link 778. Execution of the sequences of instructions contained in memory 704 causes processor 702 to perform one or more of the method steps described herein. In alternative embodiments, hardware, such as ASIC 720, may be used in place of or in combination with software to implement the invention. Thus, embodiments of the invention are not limited to any specific combination of hardware and software, unless otherwise explicitly stated herein.

The signals transmitted over network link 778 and other networks through communications interface 770, carry information to and from computer system 700. Computer system 700 can send and receive information, including program code, through the networks 780, 790 among others, through network link 778 and communications interface 770. In an example using the Internet 790, a server host 792 transmits program code for a particular application, requested by a message sent from computer 700, through Internet 790, ISP equipment 784, local network 780 and communications interface 770. The received code may be executed by processor 702 as it is received, or may be stored in memory 704 or in storage device 708 or any other non-volatile storage for later execution, or both. In this manner, computer system 700 may obtain application program code in the form of signals on a carrier wave.

Various forms of computer readable media may be involved in carrying one or more sequence of instructions or data or both to processor 702 for execution. For example, instructions and data may initially be carried on a magnetic disk of a remote computer such as host 782. The remote computer loads the instructions and data into its dynamic memory and sends the instructions and data over a telephone line using a modem. A modem local to the computer system 700 receives the instructions and data on a telephone line and uses an infra-red transmitter to convert the instructions and data to a signal on an infra-red carrier wave serving as the network link 778. An infrared detector serving as communications interface 770 receives the instructions and data carried in the infrared signal and places information representing the instructions and data onto bus 710. Bus 710 carries the information to memory 704 from which processor 702 retrieves and executes the instructions using some of the data sent with the instructions. The instructions and data received in memory 704 may optionally be stored on storage device 708, either before or after execution by the processor 702.

FIG. 8 illustrates a chip set or chip 800 upon which an embodiment of the invention may be implemented. Chip set 800 is programmed to provide communication with a service using a recipient identifier as described herein and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 800 can be implemented in a single chip. It is further contemplated that in certain embodiments the chip set or chip 800 can be implemented as a single “system on a chip.” It is further contemplated that in certain embodiments a separate ASIC would not be used, for example, and that all relevant functions as disclosed herein would be performed by a processor or processors. Chip set or chip 800, or a portion thereof, constitutes a means for performing one or more steps of providing user interface navigation information associated with the availability of functions. Chip set or chip 800, or a portion thereof, constitutes a means for performing one or more steps of providing communication with a service using a recipient identifier.

In one embodiment, the chip set or chip 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 800 includes merely one or more processors and some software and/or firmware supporting and/or relating to and/or for the one or more processors.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to provide communication with a service using a recipient identifier. The memory 805 also stores the data associated with or generated by the execution of the inventive steps.

FIG. 9 is a diagram of exemplary components of a mobile terminal (e.g., handset) for communications, which is capable of operating in the system of FIG. 1, according to one embodiment. In some embodiments, mobile terminal 901, or a portion thereof, constitutes a means for performing one or more steps of providing communication with a service using a recipient identifier. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 903, a Digital Signal Processor (DSP) 905, and a receiver/transmitter unit including a microphone gain control unit and a speaker gain control unit. A main display unit 907 provides a display to the user in support of various applications and mobile terminal functions that perform or support the steps of providing communication with a service using a recipient identifier. The display 907 includes display circuitry configured to display at least a portion of a user interface of the mobile terminal (e.g., mobile telephone). Additionally, the display 907 and display circuitry are configured to facilitate user control of at least some functions of the mobile terminal. An audio function circuitry 909 includes a microphone 911 and microphone amplifier that amplifies the speech signal output from the microphone 911. The amplified speech signal output from the microphone 911 is fed to a coder/decoder (CODEC) 913.

A radio section 915 amplifies power and converts frequency in order to communicate with a base station, which is included in a mobile communication system, via antenna 917. The power amplifier (PA) 919 and the transmitter/modulation circuitry are operationally responsive to the MCU 903, with an output from the PA 919 coupled to the duplexer 921 or circulator or antenna switch, as known in the art. The PA 919 also couples to a battery interface and power control unit 920.

In use, a user of mobile terminal 901 speaks into the microphone 911 and his or her voice along with any detected background noise is converted into an analog voltage. The analog voltage is then converted into a digital signal through the Analog to Digital Converter (ADC) 923. The control unit 903 routes the digital signal into the DSP 905 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 925 for compensation of any frequency-dependent impairments that occur during transmission though the air such as phase and amplitude distortion. After equalizing the bit stream, the modulator 927 combines the signal with a RF signal generated in the RF interface 929. The modulator 927 generates a sine wave by way of frequency or phase modulation. In order to prepare the signal for transmission, an up-converter 931 combines the sine wave output from the modulator 927 with another sine wave generated by a synthesizer 933 to achieve the desired frequency of transmission. The signal is then sent through a PA 919 to increase the signal to an appropriate power level. In practical systems, the PA 919 acts as a variable gain amplifier whose gain is controlled by the DSP 905 from information received from a network base station. The signal is then filtered within the duplexer 921 and optionally sent to an antenna coupler 935 to match impedances to provide maximum power transfer. Finally, the signal is transmitted via antenna 917 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 901 are received via antenna 917 and immediately amplified by a low noise amplifier (LNA) 937. A down-converter 939 lowers the carrier frequency while the demodulator 941 strips away the RF leaving only a digital bit stream. The signal then goes through the equalizer 925 and is processed by the DSP 905. A Digital to Analog Converter (DAC) 943 converts the signal and the resulting output is transmitted to the user through the speaker 945, all under control of a Main Control Unit (MCU) 903 which can be implemented as at least one Central Processing Unit (CPU) (not shown).

The MCU 903 receives various signals including input signals from the keyboard 947. The keyboard 947 and/or the MCU 903 in combination with other user input components (e.g., the microphone 911) comprise a user interface circuitry for managing user input. The MCU 903 runs a user interface software to facilitate user control of at least some functions of the mobile terminal 901 to provide communication with a service using a recipient identifier. The MCU 903 also delivers a display command and a switch command to the display 907 and to the speech output switching controller, respectively. Further, the MCU 903 exchanges information with the DSP 905 and can access an optionally incorporated SIM card 949 and a memory 951. In addition, the MCU 903 executes various control functions required of the terminal. The DSP 905 may, depending upon the implementation, perform any of a variety of conventional digital processing functions on the voice signals. Additionally, DSP 905 determines the background noise level of the local environment from the signals detected by microphone 911 and sets the gain of microphone 911 to a level selected to compensate for the natural tendency of the user of the mobile terminal 901.

The CODEC 913 includes the ADC 923 and DAC 943. The memory 951 stores various data including call incoming tone data and is capable of storing other data including music data received via, e.g., the global Internet. The software module could reside in RAM memory, flash memory, registers, or any other form of writable storage medium known in the art. The memory device 951 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 949 carries, for instance, important information, the carrier supplying service, subscription details, and security information. The SIM card 949 serves primarily to identify the mobile terminal 901 on a radio network. The card 949 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising:
receiving a request to generate a recipient identifier for indicating data exchanged between a service and an application on a device;
determining a user identifier, one or more device identifiers associated with the device, one or more application identifiers associated with the application, or a combination thereof; and
determining to generate the recipient identifier by encoding, at least in part, the user identifier, the one or more device identifiers, the one or more application identifiers, or a combination thereof in the recipient identifier,
wherein the user identifier, the one or more device identifiers, the one or more application identifiers, or a combination thereof are decodable directly from the recipient identifier.

2. A method of claim 1, further comprising:
determining to encrypt the recipient identifier; and
determining to transmit the encrypted recipient identifier to the application, the service, or a combination thereof without providing the user identifier and/or one or more device identifiers to the application or the service.

3. A method of claim 2, wherein the recipient identifier is generated at a server and wherein the server does not store the recipient identifier.

4. A method of claim 1, further comprising:
determining to encrypt the recipient identifier based, at least in part, on a symmetric cipher or an asymmetric cipher.

5. A method of claim 4, further comprising:
determining to select a primary key for the cipher based, at least in part, on one or more service identifiers associated with the service, one or more predetermined parameters, or a combination thereof.

6. A method of claim 5, further comprising:
determining to generate a secondary key for the cipher based, at least in part, on hash-based message authentication code constructed, at least in part, from the service identifiers, the one or more predetermined parameters, or a combination thereof.

7. A method of claim 1, further comprising:
determining to generate a message authentication code for the recipient identifier; and
determining to include the message authentication code in the recipient identifier.

8. A method of claim 2, further comprising:
receiving data including the encrypted recipient identifier;
determining to decode the user identifier, the one or more device identifiers, the one or more application identifiers, or a combination thereof directly from the data; and
determining to route the data to application based, at least in part, on the user identifier, the one or more device identifiers, the one or more application identifiers, or a combination thereof,
wherein the routing does not expose the user identifier or the one or more device identifiers to the application.

9. An apparatus comprising:
at least one processor; and
at least one memory including computer program code for one or more programs,
the at least one memory and the computer program code configured to, with the at least one processor, cause the apparatus to perform at least the following,
receive a request to generate a recipient identifier for indicating data exchanged between a service and an application on a device;
determine a user identifier, one or more device identifiers associated with the device, one or more application identifiers associated with the application, or a combination thereof; and
determine to generate the recipient identifier by encoding, at least in part, the user identifier, the one or more device identifiers, the one or more application identifiers, or a combination thereof in the recipient identifier,
wherein the user identifier, the one or more device identifiers, the one or more application identifiers, or a combination thereof are decodable directly from the recipient identifier.

10. An apparatus of claim 9, wherein the apparatus is further caused to:
determine to encrypt the recipient identifier; and
determine to transmit the encrypted recipient identifier to the application, the service, or a combination thereof without providing the user identifier and/or the one or more device identifiers to the application or the service.

11. An apparatus of claim 10, wherein the recipient identifier is generated at a server, and wherein the server does not store the recipient identifier.

12. An apparatus of claim 9, wherein the apparatus is further caused to:
determine to encrypt the recipient identifier based, at least in part, on a symmetric cipher or an asymmetric cipher.

13. An apparatus of claim 12, wherein the apparatus is further caused to:
determine to select a primary key for the cipher based, at least in part, on one or more service identifiers associated with the service; and

14. An apparatus of claim 13, wherein the apparatus is further caused to:
determine to generate a secondary key for the cipher based, at least in part, on hash-based message authentication code constructed, at least in part, from the service identifier, one or more predetermined parameters, or a combination thereof.

15. An apparatus of claim 9, wherein the apparatus is further caused to:
determine to generate a message authentication code for the recipient identifier; and
determine to include the message authentication code in the recipient identifier.

16. An apparatus of claim 10, wherein the apparatus is further caused to:
receive data including the recipient identifier;
determine to decode the user identifier, the one or more device identifiers, the one or more application identifiers, or a combination thereof directly from the data; and
determine to route the data to the application based, at least in part, on the user identifier, the one or more device identifiers, the one or more application identifiers, or a combination thereof,
wherein the routing does not expose the user identifier or the one or more device identifiers to the application.

17. A method comprising facilitating access to at least one interface configured to allow access to at least one service, the at least one service configured to perform at least the following:
receiving a request to generate a recipient identifier for indicating data exchanged between a service and an application on a device;
determining user identifier, one or more device identifiers associated with the device, one or more application identifiers associated with the application, or a combination thereof; and
determining to generate the recipient identifier by encoding, at least in part, the user identifier, the one or more device identifiers, the one or more application identifiers, or a combination thereof in the recipient identifier,
wherein the user identifier, the one or more device identifiers, the one or more application identifiers, or a combination thereof are decodable directly from the recipient identifier.

18. A method of claim 17, further comprising:
determining to encrypt the recipient identifier; and
determining to transmit the recipient identifier to the application, the service, or a combination thereof without providing the one or more device identifiers to the application or the service.

19. A method of claim 17, wherein the recipient identifier is generated at a server, and wherein the server does not store the recipient identifier.

20. A method of claim 18, further comprising:
receiving data including the encrypted recipient identifier;
determining to decode the user identifier, one or more device identifiers, the one or more application identifiers, or a combination thereof directly from the data; and
determining to route the data to the application based, at least in part, on the user identifier, the one or more device identifiers, the one or more application identifiers, or a combination thereof,
wherein the routing does not expose the user identifier or the one or more device identifiers to the application.

21.-40. (canceled)
